(19) United States
(12) Patent Application Publication
(10) Pub. No.: US 2008/0226239 A1
(43) Pub. Date: Sep. 18, 2008

(54) Optical transceiver with mechanism to dissipate heat efficiently without affecting optical coupling condition

(75) Inventors: Kazushige Oki, Kanagawa (JP); Hiromi Kurashima, Kanagawa (JP)

Correspondence Address: VENABLE LLP, P.O. BOX 34385, WASHINGTON, DC, 20043-9998, US

(73) Assignee: Sumitomo Electric Industries, Ltd., Osaka (JP)

(21) Appl. No.: 12/076,099

(22) Filed: Mar. 13, 2008

(30) Foreign Application Priority Data
Mar. 14, 2007 (JP) 2007-065273

(51) Int. Cl. G02B 6/36

(52) U.S. Cl. 385/92

(57) ABSTRACT

A heat dissipating mechanism from an optical assembly to housing without stressing the assembly against the housing is disclosed. The optical assembly has a box-shaped portion to install the optical device and the heat generating device. Among six walls of the box-shaped portion, rear and one side wall are provided for the signal transmission, and two side walls continuous to each other are provided for the heat conduction. The housing forms a hollow within which the optical assembly is set such that the two side walls of the optical assembly come in thermally contact with the bottom and one side wall of the hollow.

### BACKGROUND OF THE INVENTION

1. Field of the Invention

The present invention relates to an optical transceiver, in particular, the invention relates to a pluggable optical transceiver with a function of the optical transmission and the optical reception.

2. Related Prior Art

The pluggable transceiver has a function to be set within the host system, such as a computer and a network router, without turning off the electrical power of the host system. When the transmission speed enters a giga-hertz band (GHz), it becomes inevitable to apply a semiconductor laser diode (LD) as an optical signal source, in particular, when the transmission speed exceeds 10 GHz, the LD with a temperature controlling device is installed within a package whose shape is, what is called, the butterfly package with a box-shaped body portion and a cylindrical portion extending from one side wall of the box portion, because the performance of the LD strongly depends on the temperature thereof and it is inevitable to lower the operation temperature of the LD and to make it constant.

Typical temperature control device is the Peltier device with two plates and Peltier elements put between plates. When one of plates mounts the LD and cools down the temperature thereof, the other plate is necessary to be heated up to balance the thermal condition of the Peltier device. When the heat dissipating mechanism for the other plate is ineffective, the LD is unable to be cooled down enough to cause the failure of the optical transceiver. Various mechanisms and techniques have been proposed in the field.

For instance, the U.S. patent, the U.S. Pat. No. 6,522,486, has disclosed an semiconductor laser module with a box-shaped package installing the LD and the Peltier device. An auxiliary member caps this module and mechanically fixes the module to the board. The optical assembly applied in the pluggable transceiver further provides a sleeve that constitutes an optical receptacle and optically couples with the optical connected inserted in this optical receptacle. This sleeve is necessary to be physically aligned with the receptacle because the sleeve must mate with a ferrule in the optical connector. Therefore, when the module is pressed against the board to conduct heat effectively to the board, as disclosed in the prior art mentioned above, the physical relationship between the sleeve and the optical receptacle is occasionally violated.

Moreover, when the transceiver follows the standard of the XENPAK or the X2, which is ruled by the IEEE 802.3ae in the package thereof, the transceiver is necessary to form the mechanism, such as latch bar or hook, in the side of the transceiver to fix it with the host system, which restricts the place where the heat-dissipating mechanism to be built. Only the top or the bottom of the transceiver package may be left for the heat dissipation. Accordingly, the present invention is to provide an optical transceiver with a new arrangement to conduct heat of an optical module effectively without pressing the module against the housing of the transceiver.

### SUMMARY OF THE INVENTION

A feature of an optical transceiver according to the present invention is that, the optical transceiver includes a semiconductor optical device, an optical assembly with a body portion and a cylindrical portion and a frame. The body portion has a box-shape with six walls of front, rear, top, bottom and a pair of side walls. The cylindrical portion extends from the front wall. The top wall mounts the semiconductor optical device thereon within the box portion. The frame, which installs the optical assembly therein, provides a hollow in an inner surface thereof This hollow has a bottom and at least an inner wall formed in a center side of the frame. The hollow receives the box portion of the optical assembly as leaving a gap therebetween such that the top wall of said box portion faces the bottom of the hollow and one of the side walls faces the inner wall of the hollow. Moreover, in the optical transceiver of the invention, the gap between the box portion and the frame is filled with a gelled thermal compound.

According to the arrangement of the optical assembly of the present invention, even the optical assembly is rigidly fixed to the frame to realize the optical coupling function between the semiconductor optical device and the optical receptacle, the body portion of the optical assembly is mechanically released from the frame with a gap, but is thermally in contact with the frame by interposing a gelled thermal compound within the gap. Accordingly, the mechanical conditions and the thermal relations between the optical assembly and the frame may be consistent.

### BRIEF DESCRIPTION OF DRAWINGS

FIG. 1A is a perspective view and the FIG. 1B is a top plan view of the optical transceiver according to the present invention;

FIG. 2 is an exploded view of the optical transceiver according to the present invention;

FIG. 3 illustrates an inside of the optical transceiver, where the TOSA and the ROSA are assembled with the optical receptacle and the circuit board;

FIG. 4A is a top plan view, FIG. 4B is a side view and FIG. 4C is a perspective view of the TOSA according to the embodiment of the present invention, where the TOSA is assembled with two types of FPC boards in FIG. 4C;

FIG. 5 illustrates an inner structure of the upper frame;

FIG. 6 shows the TOSA set within the hollow of the upper frame with the thermal compound filled within the gap between the TOSA and the frame; and

FIG. 7 is a cross section taken along the ling A-A shown in FIG. 1, which shows the thermal compound filled within the gap between the TOSA and the frame.

### DESCRIPTION OF PREFERRED EMBODIMENTS

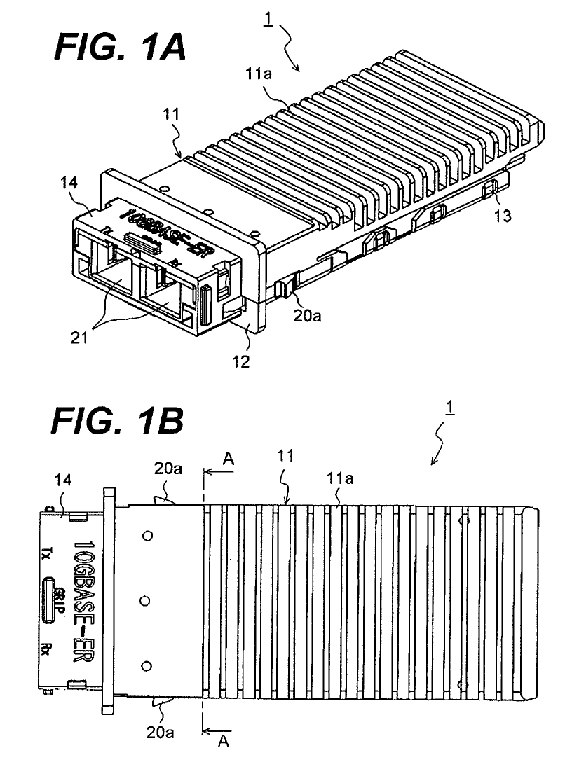

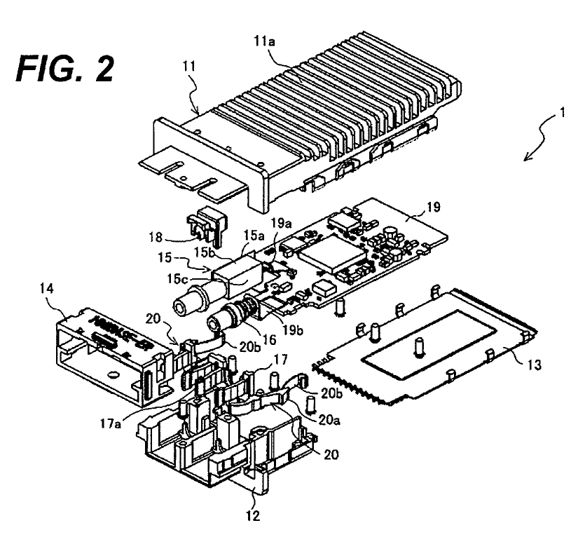

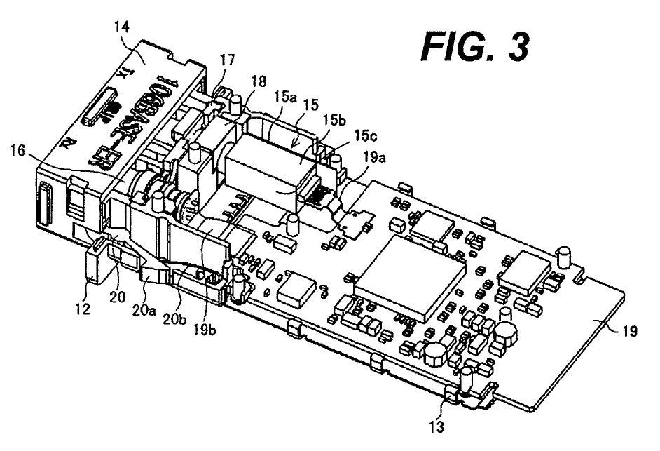

FIGS. from 1A to 3 explain the optical transceiver according to the present invention, where FIG. 1A is a perspective view, FIG. 1B is a top plan view, FIG. 2 is an exploded view, and FIG. 3 shows an inside of the transceiver that removes an upper frame from the primary assembly.

The optical transceiver 1, which is inserted into an opening formed in the face panel of the host system, comprises the upper frame 11, the lower frame 13 and the cover 13. These components form a package with the type of, what is called as, the XENPAK and the X2. The upper and lower frames, 11 and 12, form an optical receptacle 21 into which an optical connected is inserted. The description below assumes a side where this optical receptacle is formed to be the front side, while the other side to be the rear.

A side of the frames, as shown in FIG. 1B, forms a latch tab 20a. When the optical transceiver 1 is set within the rail system provided on the host substrate, this latch tab 20a mates with an aperture provided in the side of the rail system to secure the transceiver 1 within and on the host system. On the front of the frame is provided with a grip 14 that may manipulate the latch tab 20a, by sliding front and rear around the optical receptacle 21, to release the transceiver 1 from the rail system on the host board. The upper frame 11 provides, in the outer surface thereof, a plurality of thermal fins 11a to radiate heat generated by, for instance, a semiconductor optical device within the transceiver 1.

The transceiver 1 encloses a transmitter optical sub-assembly (TOSA) 15, a receiver optical sub-assembly (ROSA) 16, a holder 17, a cover 18, a substrate 19 and a latch member 20 within the frame. The TOSA 15 has a body 15a with a rectangular shape that installs a semiconductor optical device such as a laser diode (LD) and a Peltier device therein. The top wall 15b and one of sides 15c facing inside of the transceiver 1 come in thermally contact with the hollow formed inside of the upper frame 11 via a gelled thermal compound to conduct heat generated within the body portion 15a efficiently to the upper frame 11 through the top wall 15b and the side wall 15c of the body portion 15a interposing the thermal compound, and to radiate heat from the fins 11a of the upper frame 11. The ROSA 16, on the other hand, installs a photodiode as a semiconductor optical device which is insensitive to a temperature compared to the LD, accordingly, the ROSA 16 is unnecessary to provide a specific mechanism to dissipate heat in the present embodiment.

The holder 17 secures the TOSA 15 and the ROSA 16 against the lower frame 12. The holder 17 also provides two pairs of latch tabs whose shapes and functions follow the standard of the SC type connector. The bracket 18 fixes the TOSA 15 in a center portion thereof to the holder 17, in which the TOSA 15 is put between the holder 17 and the bracket 18 in a center portion to align the position along a direction perpendicular to the optical axis of the TOSA 18. That is, the arrangement shown determines the up-and-down direction of the TOSA 18 with respect to the optical axis. The circuit board 19 mounts an electronic circuit including a plurality of ICs. Flexible printed circuit (FPC) boards, 19a and 19b, electrically connect the TOSA 15 and ROSA 16 with the circuit board, respectively. The latch member includes the latch tab 20a, which extrudes from the side of the frame to mate with the rail on the host board, and a leaf spring 20b to elastically push out the latch tab 15, which enables the latch tab 15a to mate with the rail.

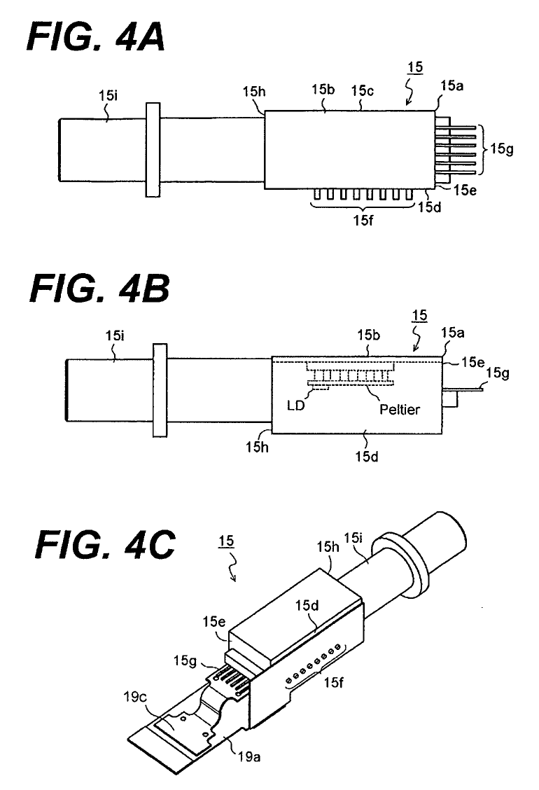

Next, the upper frame of the optical transceiver 1 and the TOSA 18 will be described in detail. FIGS. 4A to 4C illustrates the appearance of the TOSA 15, where FIG. 4A is a plan view, FIG. 4B is a side view and FIG. 4C is a perspective view of the TOSA 15 assembled with the FPC board 19a.

The TOSA 15 comprises the body portion 15a with the box shape and a cylindrical portion 15i extending from one side wall of the body portion 15a. The optical axis of the TOSA 15 is identical with a center of the cylindrical portion 15i, which is also identical with the optical axis of the receptacle. The body portion 15a encloses the LD and the Peltier device with lower and upper plates, which are shown by dotted lines in the figure. The upper plates of the Peltier device mounts the LD thereof, while, the lower plate thereof comes in directly contact with the inner surface of the top 15b of the body portion 15a. That is, the Peltier device is installed within the body portion 15a in upside-down. When the upper plate of the Peltier device is cooled down to set the temperature of the LD to be a preset condition, the lower plate in contact with the top wall 15b is heated up. The TOSA 15 is necessary to dissipate this heat of the Peltier device through the top 15b.

The side wall 15c of the TOSA 15 continuous to the top wall 15b may be also formed by a metal with good thermal conductivity, which may conduct heat generated by the Peltier device to the outside of the body portion 15a. This side wall 15c of the body portion 15a faces the center wall 11e of the upper frame 11, which will be described later. Thus, the top wall 15b and the inner side wall 15c of the body portion 15a operate as a heat conducting surface for the heat generated by the Peltier device.

The body portion 15a provides a plurality of lead pins, 15f and 15g, one group of which extends from the outer side wall 15d and the other group of which extends from the rear side wall 15e. The outer side wall 15d means that, when the TOSA 15 is set on the upper frame 11, the outer side wall 15d faces the outside of the transceiver 1, while the inner side wall 15c faces the center wall 11e of the upper frame 11.

One group of lead pins, 15g, extending from the real wall 15e connect with the FPC board 19c, while the other group of lead pins, 15f, extending from the outer wall 15d are connected with the other FPC board 19a. Moreover, the former FPC board 19c, which transmits signals with high frequency components to drive the LD, is connected with the circuit board 19 in one surface therefore, while, the latter FPC board 19a, which conducts signals to control the Peltier device and is configured with relatively lower frequency components, is connected with the circuit board 19 in the other surface. Thus, in the present TOSA 15, two types of signals are provided with individual FPC boards, 19a and 19c, each extending from different surfaces of the circuit board 15. The FPC board 19a connected with the side lead pins 15 is configured to extend downward from the side 15d, to be bent inward in the bottom of the body portion, and to extend rearward to connect with the circuit board 15, as shown in FIG. 4C.

According to the arrangement of two FPC boards, 19a and 19c, even if two types of signals, one of which includes relatively higher frequency components while the other of which has lower frequency components or the power supply line, are individually provided to the TOSA 15 from the circuit board 19, the former signals may be transmitted with the shorter FPC board 19c so as not to degrade the signal quality even in high frequency regions, while, the latter signals may be provided without affecting the heat dissipating function of the TOSA 15.

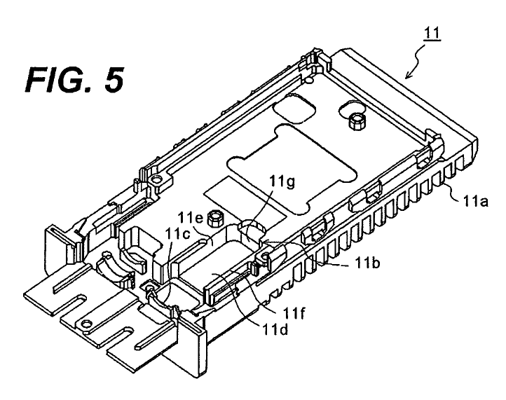

FIG. 5 illustrates an inside of the upper frame 11. The upper frame 11, which may be made of aluminum with nickel plating, provides the thermal fin 11a in the outside thereof, while the frame 11 provides the hollow 11b and the saddle 11c in the inside thereof. When the TOSA 15 is assembled with the frame 11, the hollow 11b receives the body portion 15a of the TOSA 15, while, the saddle 11c supports the cylindrical portion 15c.

The hollow 11b provides three side walls, 11f to 11g, and bottom 11d. When the TOSA 15 is assembled with the upper frame 11, the bottom 11d comes in contact with the top 15b of the body portion 15a, while the side walls, 11f to 11g, face to the sides, 15c to 15e, of the body portion 15a, respectively. Moreover, between the top 15b and the bottom 11d, and between one of the sides 15c and one of the side walls 11e are filled with a gelled thermal compound 22.

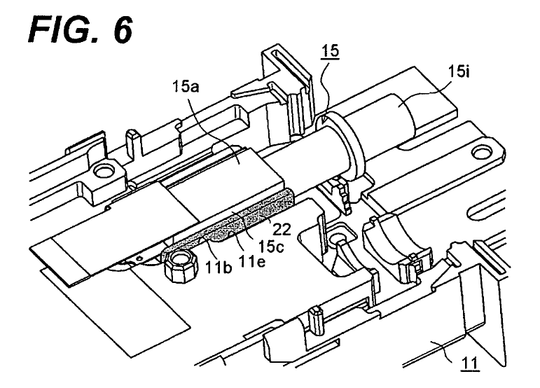

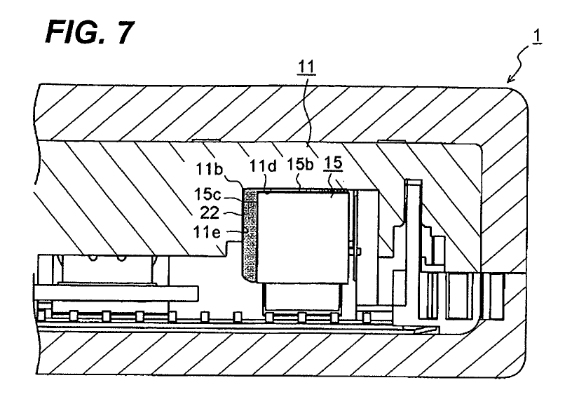

FIG. 6 illustrates the TOSA 15 set within the hollow 11b of the upper frame 11 with the gelled compound 22 within the gap between the side wall 11e and the side 15c of the body portion 15a, while, FIG. 7 is a cross section taken along the line A-A shown in FIG. 1B.

As shown in FIG. 6, the TOSA 15 in the body portion 15a thereof is set within the hollow 11b and the cylindrical portion 15i is secured on the saddle 11c. Moreover, between the side wall 15c of the body portion 15 and the side wall 11e of the hollow 11b is filled with the gelled thermal compound 22 to secure the heat conducting path. Between the top 15b of the body portion 15a and the bottom 11d of the hollow 11b is similarly filled with the gelled thermal compound. Accordingly, two walls, 15b and 15c, of the body portion 15a of the TOSA 15 may face to the upper frame 11 via the thermal compound without forming any air-gap, which effectively dissipates heat generated in the TOSA 15 to upper frame 11 and radiates from the thermal fin 11a to the outside of the transceiver 1. Moreover, the gelled thermal compound 22 is in the hollow 11b of the frame 11, which prevents the compound 22 from oozing out and from extending within the frame 11.

The gelled thermal compound 22 of the present invention may be a type of silicon resin, which enables for the TOSA 15 to be in thermally contact with the frame 11 without pressing the TOSA against the frame. Although the embodiment described above concentrates on the TOSA, the arrangement of the body portion of the TOSA, the FPC boards, and the inner structure of the frame may be also applicable to the ROSA when the ROSA installs devices to generate large heat.

While the preferred embodiments of the present invention have been described in detail above, many changes to these embodiments may be made without departing from the true scope and teachings of the present invention. The present invention, therefore, is limited only as claimed below and the equivalents thereof.

We claim:

1. An optical transceiver, comprising:
a semiconductor optical device;
an optical assembly with a body portion and a cylindrical portion, said body portion having a box-shape with a front wall, a rear wall, a top wall, a bottom wall, and a pair of side walls, said cylindrical portion extending from said front wall, said top wall mounting said semiconductor optical device thereon within said box portion; and
a frame to install said optical assembly therein, said frame providing a hollow in an inner surface thereof, said hollow having a bottom and at least an inner wall formed in a center portion of said frame to receive said box portion as leaving a gap therebetween such that said top wall of said box portion faces said bottom of said hollow and one of said side walls faces said inner wall of said hollow,
wherein said gap between said box portion and said frame is filled with a gelled thermal compound.

2. The optical transceiver according to claim 1,
wherein said optical device is mounted on said top wall of said box portion via a thermo-electric element.

3. The optical transceiver according to claim 1,
wherein said frame provides a plurality of thermal fins to radiate heat conducted from said optical assembly via said gelled thermal compound.

4. The optical transceiver according to claim 1,
wherein said optical assembly provides two groups of lead pins, one group of lead pins extending from said rear wall opposite to said front wall, the other group of said lead pins extending from the other of said side walls opposite to said side wall facing said inner wall of said hollow.

5. The optical transceiver according to claim 4,
further comprising a circuit board mounting an electronic circuit thereon electrically coupled with said optical module with two flexible printed circuit board each connected with said one group and the other group of said lead pins, respectively,
wherein one of said flexible printed circuit boards is connected with a top surface of said electronic circuit board and the other of said flexible printed circuit boards is connected with a bottom surface of said electronic circuit board.

6. The optical transceiver according to claim 5,
wherein one of said flexible printed circuit board connected with said first group of said lead pins carries signals with relatively high frequency components without any folding, and
wherein said other of said flexible printed circuit board connected with said second group of said lead pins is configured to carry signals with relatively low frequency components, to be folded from said other of said side walls toward said bottom wall of said body portion and to extend toward said circuit board.

7. The optical transceiver according to claim 1,
wherein said frame provides a saddle to receive said cylindrical portion of said optical module to align said optical module in up-and-down direction perpendicular to an optical axis of said optical assembly.
